(19) United States
(12) Patent Application Publication
(10) Pub. No.: US 2006/0111130 A1
(43) Pub. Date: May 25, 2006

(54) Method and apparatus for transmitting SMS message between mobile communication network and WLAN and system using the same

(75) Inventors: Sang-Do Lee, Suwon-si (KR); Dong-Soo Park, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/265,497

(22) Filed: Nov. 3, 2005

(30) Foreign Application Priority Data
Nov. 3, 2004 (KR) 2004-89039

(51) Int. Cl. H04Q 7/20

(52) U.S. Cl. 455/466

(57) ABSTRACT

A method and system for providing a short message service (SMS) between a cellular mobile communication network and an IEEE 802.11 WLAN are provided. To provide the SMS between the mobile communication network and the WLAN, a short message gateway (SMGW) is further provided between existing SS7 network and IP network. A mobile terminal (MT) connected to the cellular network is allocated radio resources by a base transceiver station (BTS). One or more BTSs are connected to a mobile switching center (MSC) through a base station controller (BSC). The MSC is connected to an SMS center (SMSC), a home location register (HLR), and the SMGW through the SS7 network. An MT connected to the WLAN is wirelessly connected to an access point (AP) and one or more APs are connected to the IP network and the SMGW through an access router (AR).

### PRIORITY

This application claims the benefit under 35 U.S.C. § 119(a) of Korean Patent Application No. 2004-89039 entitled “Method and Apparatus for Transmitting SMS Message Between Mobile Communication Network and WLAN and System Using the Same,” filed in the Korean Intellectual Property Office on Nov. 3, 2004, the entire contents of which are hereby incorporated by reference.

### BACKGROUND OF THE INVENTION

1. Field of the Invention:

The present invention relates generally to a method and apparatus for providing Short Message Service (SMS) between heterogeneous networks. More particularly, the present invention relates to a method and apparatus for providing SMS in a cellular mobile communication network and an Internet Protocol (IP)-based Wireless Local Area Network (WLAN) which supports SMS, and a system using the same.

1. Description of the Related Art:

Conventional Mobile communication networks that provide voice service adopt multiple access schemes to identify users. The multiple access schemes include Frequency Division Multiple Access (FDMA), Time Division Multiple Access (TDMA), and Code Division Multiple Access (CDMA). FDMA divides a given spectrum into channels and each user is allocated one frequency channel. TDMA allows a number of users to access a frequency channel by allocating unique time slots to each user within the channel. Unlike FDMA and TDMA, CDMA utilizes the same frequency band for a plurality of subscribers at the same time and a call for each subscriber is uniquely encoded and transmitted across the frequency band.

The rapid development of communication technology has driven mobile communication networks to provide high-speed data service in addition to traditional voice service. High-speed data service enables multimedia service involving transmission of moving pictures as well as e-mail and still images. So-called 3rd generation mobile communication systems supporting both voice service and packet service include synchronous CDMA2000 1×, 1×Evolution-Data Only (EVDO) capable of high-speed packet transmission, 1×Evolution-Data and Voice (EV-DV), and asynchronous Universal Mobile Telecommunication System (UMTS).

Traditionally, voice service is provided over a circuit-switched network, such as the Public Switched Telephone Network (PSTN), and packet service over an IP network.

While packet data service was originally provided through Personal Computer (PC) or wired networks, it is now available through WLAN, too. Hence, the packet data service can be received with a mobile terminal (MT), such as a cellular phone.

FIG. 1 illustrates the configurations of a typical cellular mobile communication system and a typical WLAN in parallel.

Referring to FIG. 1, an MT 130 includes a radio transmitter/receiver for providing a radio interface with a Base Transceiver Station (BTS) 100 by a predetermined radio protocol. The BTS 100 allocates radio resources to the MT 130 and receives data from the MT 130. The MT 130 wirelessly accesses the BTS 100 within the coverage area of the BTS 100 (that is, cell) and transmits/receives voice and data to/from the BTS 100. As the MT 130 is capable of accessing both a mobile communication network 106 and a WLAN 140, it is called a Hybrid Access Terminal (HAT).

One or more BTSs 100 are connected to a Base Station Controller (BSC) 102. The BSC 102 manages and controls the BTSs 100. It also takes charge of implementing overall functions associated with radio resource management. One or more BSCs 102 are connected to a Mobile Switching Center (MSC) 104.

The MSC 104 provides the functions of circuit switching between subscribers, call setup, call path setup, handoff, and roaming, in addition to those provided by a standard communication switch. The MSC 104 is connected to a PSTN 108. It is also connected to a Signaling System 7 (SS7) network 110 via a No. 7 interface, and thus connected to an SMS center (SMSC) 112 and a Home Location Register (HLR) 114 through the SS7 network 110.

The SMSC 112 stores/transfers incoming/outgoing SMS messages, connects to a network, and connects to a service provider. The SMSC 112 is an independent node having a unique Signaling Point Code (SPC) in the SS7 network 110. The SMSC 112, connected to the HLR 114 and the MSC 104, locates a receiving mobile subscriber and transmits an SMS message to the mobile subscriber over a Public Land Mobile Network (PLMN).

The HLR 114 is a database center for managing information about the status and statistics of mobile subscribers, including the current location information of the HAT 130 and service-related information. The HLR 114 is also connected to the SS7 network 110.

With respect to WLAN 140, HAT 141 wirelessly communicates with an Access Point (AP) 116 that is compliant with Institute of Electrical and Electronics Engineers (IEEE) 802.16-based Wireless Broadband Internet (WiBro), or IEEE 802.20. The AP 116 is connected to an Access Router (AR) 118 by a Session Initiation Protocol (SIP). As the HAT 141 is connected to the WLAN 140, and can access the Internet 120 via WLAN 140, the AR 118 processes all IP packets between the Internet 120 and the HAT 141.

Conventional mobile communication systems boast a wide range of services, relative to the WLAN, yet it suffers from low data rate and high price. By contrast, the WLAN delivers a large amount of data at high data rate with low cost to users, compared to the data service provided by the mobile communication system. Thus, the WLAN attracts more and more users. Despite these benefits, however, one of the challenges encountered with setting up a WLAN is limited service range and too narrow a frequency bandwidth to accommodate a large number of subscribers. Moreover, it is difficult to provide high-quality service with the WLAN because of its susceptibility to interference.

Since the mobile communication network and the WLAN can each overcome the problems of the other, studies are made on interworking between them.

As described above, the mobile communication network and the WLAN are based on independent standards. While a voice call is transferred between them, the SMS remains yet to be provided between them.

Accordingly, a need exists for developing a method, apparatus, and system for providing an SMS between heterogeneous networks like the cellular network 106 and WLAN 140 because they work based on different protocols and different connection standards.

### SUMMARY OF THE INVENTION

An object of the present invention is to address at least the above problems and disadvantages and to provide at least the advantages below. Accordingly, an object of the present invention is to provide a method and apparatus for providing an SMS between heterogeneous networks without a modification to existing systems, and a system using the same.

Another object of the present invention is to provide a method and apparatus for providing an SMS between an MT in a mobile communication system and an MT in a WLAN, and a system using the same.

The above exemplary objects are achieved by providing an apparatus and method for providing an SMS between a cellular mobile communication network and a WLAN, and a system using the same.

According to one aspect of the present invention, in an SMGW for transmitting an SMS message from a transmitting MT connected to a mobile communication network to a receiving MT connected to a WLAN in a communication system, upon request of transmission of an SMS message from the transmitting MT, a first protocol processor signals the ID of the receiving MT. A first interface couples data between the mobile communication network and the first protocol processor. A subscriber information database stores information about the location of the receiving MT connected to the WLAN, the IDs of MTs in the mobile communication network and the WLAN, and IP addresses mapped to the IDs. A second protocol processor converts the IP address of the receiving MT to a URI of the receiving MT. A second interface couples data between the second protocol processor and the WLAN.

According to another aspect of the present invention, in a method of transmitting an SMS message from a transmitting MT connected to a mobile communication network to a receiving MT connected to a WLAN in an SMGW, upon request of transmission of an SMS message from the transmitting MT, the ID of the receiving MT is signaled and an IP address corresponding to the ID of the receiving MT is detected. The IP address of the receiving MT is converted to a URI.

According to a another aspect of the present invention, in an SMGW for transmitting an SMS message from a transmitting MT connected to a WLAN to a receiving MT connected to a mobile communication network in a communication system, upon request of transmission of an SMS message from the transmitting MT, a second protocol processor converts a URI of the receiving MT to an IP address of the receiving MT. A second interface couples data between the second protocol processor and the WLAN. A subscriber information database stores an ID of the receiving MT mapped to the IP address of the receiving MT. A first protocol processor signals the ID of the receiving MT. A first interface couples data between the mobile communication network and the first protocol processor.

According to another aspect of the present invention, in a method of transmitting an SMS message from a transmitting MT connected to a WLAN to a receiving MT connected to a mobile communication network in an SMGW, upon request of transmission of an SMS message from the transmitting MT, a URI of the receiving MT is converted to an IP address of the receiving MT. An ID of the receiving MT mapped to the IP address of the receiving MT is detected and the SMS message is transmitted to the receiving MT according to the ID of the receiving MT.

According to another aspect of the present invention, in a system for transmitting an SMS message from a transmitting MT connected to a mobile communication network to a receiving MT connected to a WLAN, an SMSC receives an SMS request message from the transmitting MT, asks an HLR about the location of the receiving MT, and transmits an SMS delivery point-to-point message to an SMGW that can transmit an SMS message originating from the transmitting MT to the receiving MT. The HLR receives the SMS request message from the SMSC and transmits the SMS request message to the SMGW according to the location of the receiving MT. The SMGW receives the SMS request message from the HLTR, transmits a response message for the SMS request message to the SMSC, and transmits the SMS message to the receiving MT according to the SMS delivery point-to-point message received from the SMSC.

According to another aspect of the present invention, in a system for transmitting an SMS message from a transmitting MT connected to a WLAN to a receiving MT connected to a mobile communication network, upon request of transmission of an SMS message from the transmitting MT, an SMGW transmits an SMS delivery point-to-point message to an SMSC that can transmit the SMS message to the receiving MT. The SMSC receives an SMS delivery point-to-point message from the SMGW, asks an HLR about the location of the receiving MT, and transmits the SMS message to the receiving MT when the receiving MT is located.

According to another aspect of the present invention, in a method of transmitting an SMS message from a transmitting MT connected to a mobile communication network to a receiving MT connected to a WLAN, upon request of transmission of an SMS message from the transmitting MT, an SMSC asks an HLR about the location of the receiving MT. The HLR searches an internal database and transmits an SMS request message to an SMGW that can transmit the SMS message to the receiving MT, if the receiving MT is connected to the WLAN. The SMGW transmits the SMS request message to the SMSC, if the receiving MT is within the coverage area of the SMGW. The SMSC transmits an SMS delivery point-to-point message including an ID of the receiving MT to the SMGW. The SMGW transmits the SMS message to the receiving MT.

According to another aspect of the present invention, in a method of transmitting an SMS message from a transmitting MT connected to a WLAN to a receiving MT connected to a mobile communication network, upon request of transmission of an SMS message from the transmitting MT, an SMGW transmits an SMS delivery point-to-point message to an SMSC. The SMSC transmits an SMS request message to an HLR to ask about the location of the receiving MT. The HLR detects the location of the receiving MT and transmits the SMS request message to an MSC. The MSC transmits an SMS response message to the HLR. The HLR transmits the SMS response message to the SMSC. The SMSC transmits the SMS message to the receiving MT.

### BRIEF DESCRIPTION OF THE DRAWINGS

The above and other exemplary objects, features and advantages of the present invention will become more apparent from the following detailed description of certain exemplary embodiments with reference to the accompanying drawings, in which:

FIG. 1 illustrates the configurations of existing cellular mobile communication system and WLAN;

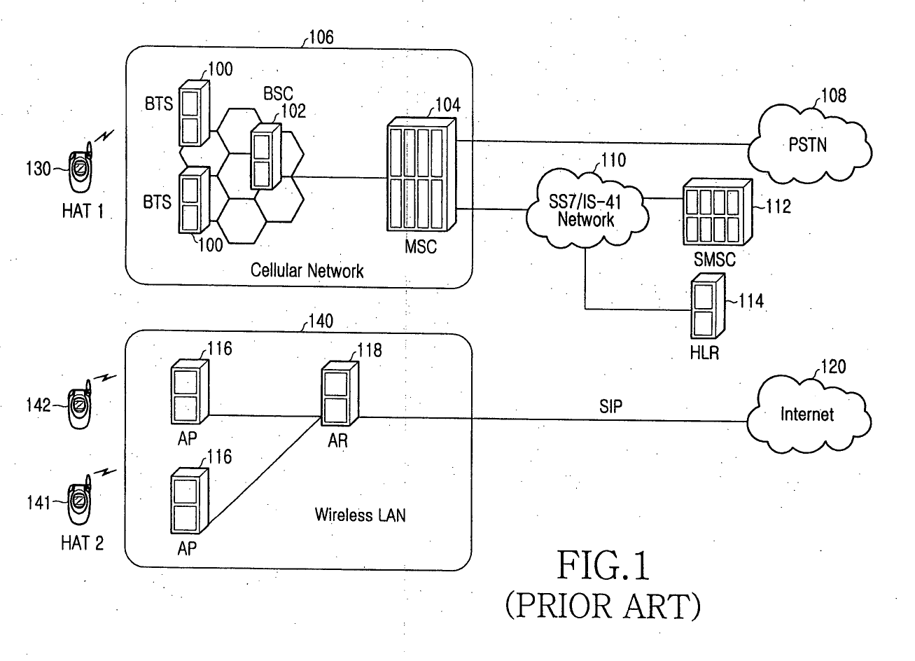

FIG. 2 illustrates a network configuration for providing the SMS between a mobile communication network and a WLAN according to an exemplary embodiment of the present invention;

FIG. 3 is a block diagram of a Short Message GateWay (SMGW) further provided according to an exemplary embodiment of the present invention;

FIG. 4 is a diagram illustrating signal flow for registering the location of an MT connected to the WLAN according to an exemplary embodiment of the present invention;

FIG. 5 is a diagram illustrating signal flow for an operation for transmitting an SMS message from an MT connected to the cellular mobile communication network to an MT connected to the WLAN according to an exemplary embodiment of the present invention;

FIG. 6 is a diagram illustrating signal flow for an operation for transmitting an SMS message from the MT connected to the WLAN to the MT connected to the cellular mobile communication network according to an exemplary embodiment of the present invention; and

FIG. 7 is a flowchart illustrating an operation for transmitting a received IP packet from an AR to an AP according to an exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

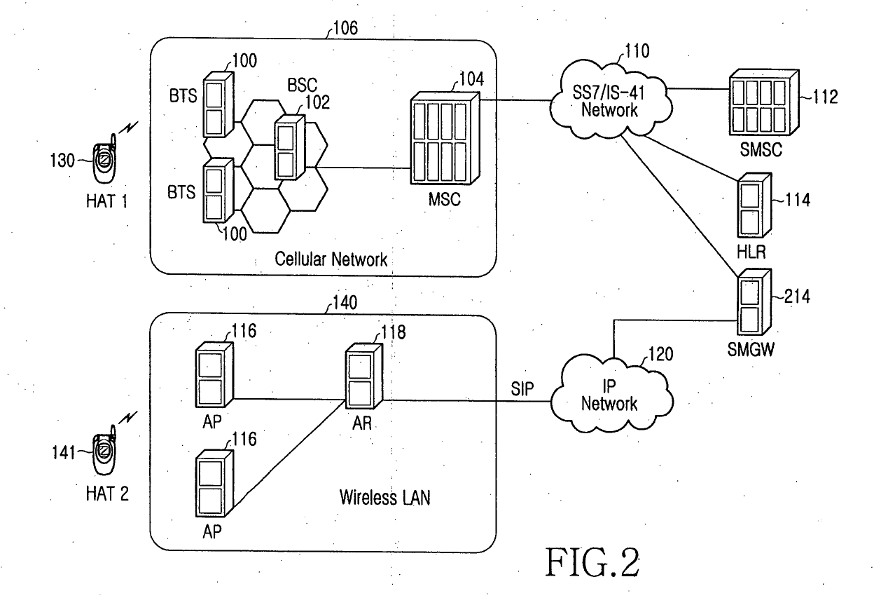

FIG. 2 illustrates a network configuration for providing the SMS between a mobile communication network and a WLAN according to an exemplary embodiment of the present invention.

Exemplary aspects of the present invention are based on the premise that the HATs 130 and 141 are single-mode terminals that can access a cellular mobile communication system or a WLAN alone, or dual-mode ones that can access both. The cellular mobile communication system is compliant with the CDMA2000 1× standards, and the WLAN is compliant with IEEE 802.11-based Wi-Fi, IEEE 802.16-based WiBro, or IEEE 802.20. The mobile communication system and the WLAN already have their protocols. Hereinbelow, the WLAN protocol standards will be represented as IEEE 802.11 or 802.16 and any system conforming to these WLAN protocol standards is called a WLAN system.

Referring to FIG. 2, the HAT 130 capable of selectively accessing the WLAN or the cellular network is connected to the cellular network 106 and thus operates in CDMA2000 1×. The HAT 141 connected to the WLAN operates according to IEEE 802.11 or 802.16. The HAT 130 is connected to the MSC 104 through the BTS 100 and the BSC 102 that form a radio access network in the mobile communication system. The BTS 100 handles radio access protocols regarding the HAT 130 in the cellular network 106. The MSC 104 interfaces between HATs or between a HAT and the PSTN.

The MSC 104 is connected to the SMSC 112 and the HLR 114 through the SS7 network 110. The SMSC 112 stores and transfers the SMS messages for SMS subscribers. The HLR 114 stores and manages the service profiles and location registration information of users connected to the cellular network. In accordance with an exemplary embodiment of the present invention, an SMGW 214 is further provided, which is connected to the cellular network 106 through the SS7 network 110 and to the WLAN 140 through the IP network 120.

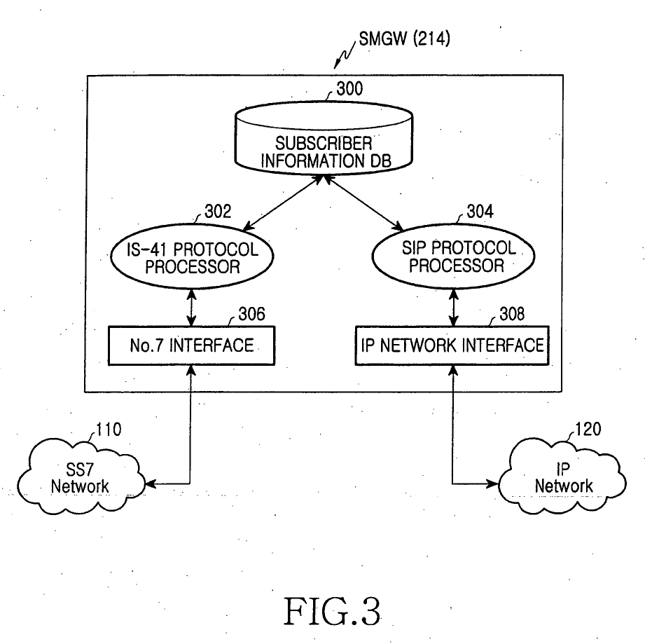

FIG. 3 is a block diagram of the SMGW 214 according to an exemplary embodiment of the present invention. The SMGW 214 has a plurality of function blocks for active communications between the heterogeneous networks.

Referring to FIG. 3, the SMGW 214 includes a subscriber information database (DB) 300 for storing information about SMS subscribers, for example, the Mobile Identity Numbers (MINs) of HATs used in their telephone network and mobile communication network, IP addresses mapped to the MINs, and the locations of HATs connected to the WLAN 140. In accordance with one exemplary embodiment of the present invention, the cellular network 106 communicates with the SMGW 214 through an Interim Standard (IS)-41 protocol processor 302 and the IP network 120 communicates with the SMGW 214 through an SIP protocol processor 304.

The IS-41 protocol processor 302 communicates with the MSC 104 or the HLR 114 connected to the SS7 network 110 through a No. 7 interface 306. The SIP protocol processor 304 communicates with the AR 118 connected to the IP network 120 through an IP network interface 308. The IS-41 protocol processor 302 operates in compliance with protocols preset with the HLR 114 and the MSC 104 to locate the HAT 130 within the cellular network 106 and transmit/receive SMS messages to/from the HAT 130. The SIP protocol processor 304 handles a protocol preset to receive location registration information from the HAT 141 within the WLAN 140 and transmit/receive SMS messages to/from the HAT 141.

In operation, when the HAT 130 transmits an SMS message to the HAT 141, the IS-41 protocol processor 302 provides the MIN information of the receiving HAT 141 to the subscriber information DB 300.

The subscriber information DB 300 outputs the IP address of the HAT 141 corresponding to the MIN information to the SIP protocol processor 304. The SIP protocol processor 304 converts the IP address to a Uniform Resource Identifier (URI), the ID of the HAT 141 in the IP network 120.

Meanwhile, when the HAT 141 originates an SMS message to the HAT 130, the SIP protocol processor 304 converts the URI of the HAT 141 received from the IP network 120 to an IP address and outputs the IP address to the subscriber information DB 300. The subscriber information DB 300 provides the MIN of the HAT 141 corresponding to the IP address to the IS-41 protocol processor 302.

SMS messages can be exchanged between different MTs within the cellular network in the existing SMS procedure. Therefore, a description will be made of exchanging SMS messages between the HAT 141 connected to the WLAN 140 and the HAT 130 connected to the cellular network 106, or between the HAT 141 connected to the WLAN, and an associated system.

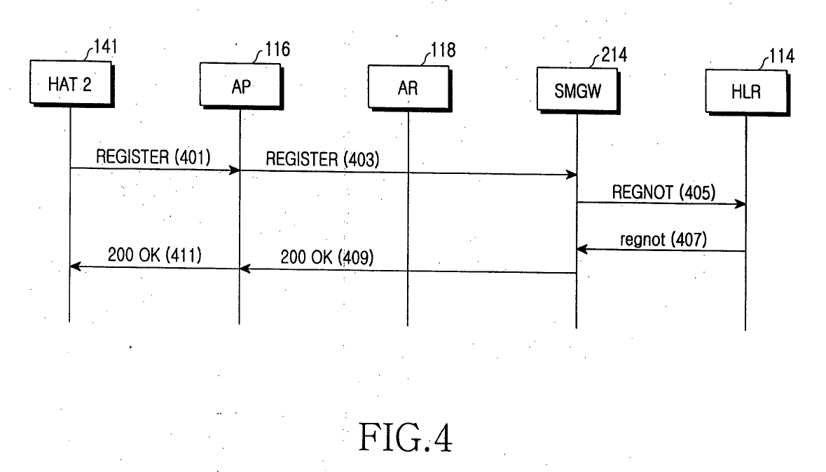

If the HAT 141 is to receive an SMS message from the cellular network 106, it must register its location in order to notify the cellular network 106 of the location. The location registration will be described with reference to FIG. 4.

FIG. 4 is a diagram illustrating signal flow for registration of the HAT 2 within the WLAN 140 according to an exemplary embodiment of the present invention.

Referring to FIG. 4, when the HAT 141 moves to the WLAN 140 or is initially power-on within the WLAN 140, it establishes the SIP to the SMGW 214. In step 401, the HAT 141 transmits a REGISTER message to the AP 116 to register its location.

The AP 116 transmits the REGISTER message to the SMGW 214 through the AR 118 in step 403. In step 405, the SMGW 214 stores the IP address and MIN of the HAT 141 included in the REGISTER message in the subscriber information DB 300 and transmits to the HLR 114 a REGISTRATION NOTIFICATION (REGNOT) message notifying the connection of the HAT 141 to the WLAN 140.

The HLR 114 recognizes that the HAT 141 has been connected to the WLAN 140 from the received REGNOT message. The HLR 114 then stores the received location information of the HAT 141 and transmits a REGISTRAITON NOTIFICATION RESPONSE (regnot) message to the SMGW 214 in step 407.

The SMGW 214 transmits a 200 OK message as a response for the registration request of the HAT 141 to the AP 116 through the AR 118 in step 409. The AP 116 transmits the 200 OK message to the HAT 141 in step 411. Thus, the location registration is completed.

For the HAT 130 within the cellular network 106 to transmit an SMS message to the HAT 141 that has registered its location to the SMGW 214 and the HLR 114 in the above procedure, the following procedure is performed.

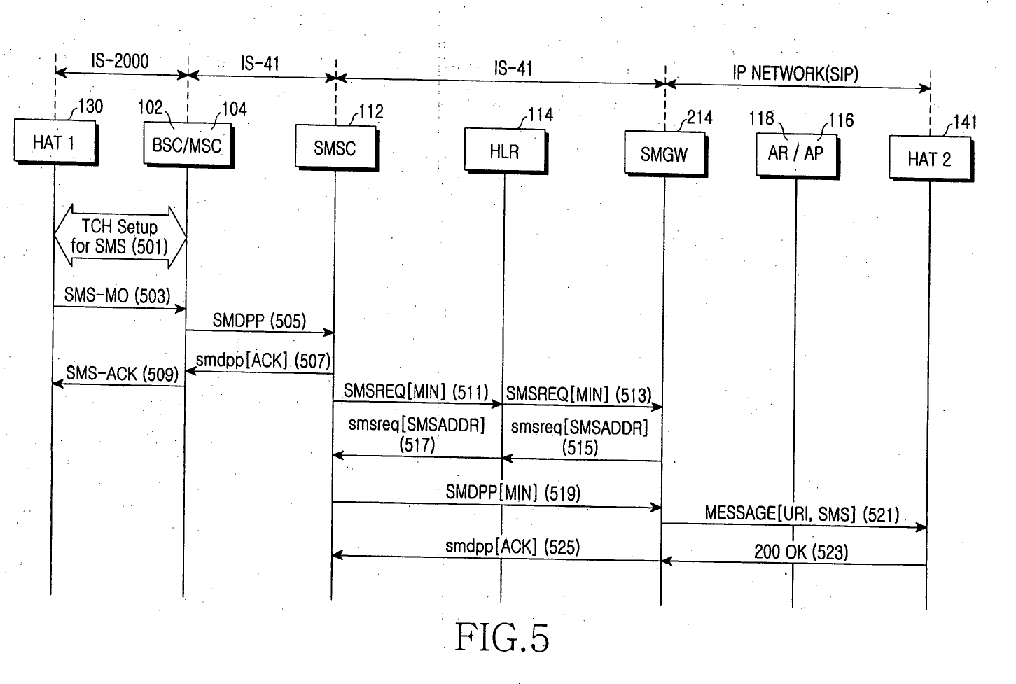

FIG. 5 is a diagram illustrating signal flow for an operation for transmitting an SMS message from the HAT 130 within the cellular network 106 to the HAT 141 within the WLAN 140 according to an exemplary embodiment of the present invention.

Before describing FIG. 5, it is assumed that the HAT 130 works according to IS-2000, an extension of the CDMA radio access standard, IS-95. The MSC 104 and the SMGW 214 communicate based on IS-41 and the SMGW 214 and the HAT 141 communicate by the SIP.

Referring to FIG. 5, to transmit an SMS message, the HAT 130 is allocated radio resources, including a Traffic Channel (TCH), by the BSC 102 and the MSC 104 in the cellular network 106 in step 501. After successful setup of radio resources, the HAT 130 transmits to the MSC 104 an SMS-Mobile Originated (SMS-MO) message including the contents of an SMS message destined for the HAT 141 in step 503.

In step 505, the MSC 104 generates an SMS Delivery Point-to-Point (SMDPP) message including the MINs of the HAT 130 and the HAT 141 and provides the SMDPP message with the contents of the SMS message to the SMSC 112.

The SMSC 112 transmits an smdpp message (smdpp[ACK]) as a response message for the SMDPP message to the MSC 104 in step 507. In step 509, the MSC 104 transmits an SMS-ACK message for the SMS message originated from the HAT 130 to the HAT 130 through the BSC 102. Thus, the HAT 130 knows that the SMS message has been successfully transmitted to the SMSC 112.

In step 511, the SMSC 112 transmits an SMSREQ message (SMREQ[MIN]) to the HLR 114 to ask about the location of the SMGW 214 to which the HAT 141 belongs using the MIN of the HAT 141 included in the SMDPP message and thus to locate the HAT 141.

The HLR 114 searches for the location information of the HAT 141 using the called number (that is, MIN) of the HAT 141 and transmits the SMSREQ message (SMSREQ[MIN]) to the SMGW 214 using the searched location information in step 513.

The SMGW 214 detects the IP address of the HAT 141 using the MIN included in the SMSREQ message and transmits to the HLR 114 an SMS request response message (smsreq[SMSADDR]) as a response message for the SMSREQ message, including an SMS address (SMSADDR) being the routing address of an SMS processing device, required to receive the SMS message from the HAT 130 in step 515.

In step 517, the HLR 114 detects the location information of the SMSC 112 to which the HAT 130 belongs using the SMSADDR and transmits the SMS request response message(smsreq[SMSADDR]) as a response message for the SMSREQ message to the SMSC 112.

In step 519, the SMSC 112 generates an SMDPP message (SMDPP[MIN]) using the SMSADR and transmits the SMDPP message with the SMS message to the SMGW 214.

The SMGW 214 detects the IP address of the HAT 141 by searching for the location information of the HAT 141 based on the SMDPP message in step 521. The SMGW 214 converts the IP address of a URI used in the IP network, equivalent to the MIN of the HAT 141. Then the SMGW 214 generates a MESSAGE message (MESSAGE[URI, SMS]), including the SMS message and transmits it to the HAT 141 within the WLAN 140 using the URI in step 521.

In step 523, the HAT 141 generates a 200 OK message to the SMGW 214. Thus, the SMGW 214 transmits an smdpp message (smdpp[ACK]) as a response message for the SMDPP[MIN] message to the SMSC 112 in step 525, thereby completing the SMS message transmission.

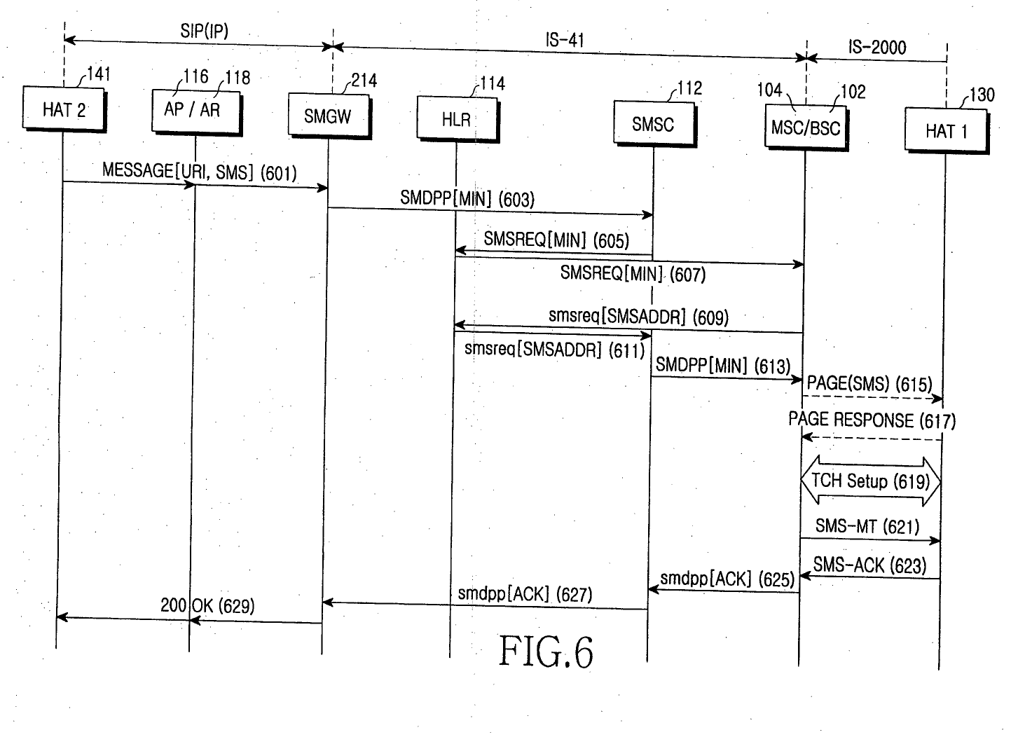

Now a description will be made of an operation for transmitting an SMS message from the HAT 141 within the WLAN 140 to the HAT 130 within the cellular network 106 with reference to FIG. 6.

Referring to FIG. 6, upon request for transmission of an SMS message from the user, the HAT 141 transmits to the SMGW 214 a MESSAGE message (MESSAGE[URI, SMS]), including the MIN of the receiving HAT 130, the SMS message, and the URI of the transmitting HAT 141 in step 601.

The SMGW 214 generates an SMDPP message (SMDPP[MIN]) including the SMS message and the MIN of the HAT 130 and transmits it to the SMSC 112 in step 603. In step 605, the SMSC 112 transmits an SMSREQ message (SMSREQ[MIN]) including the MIN of the HAT to the receiving HLR 114 to obtain the MSC 104 to which the HAT 130 belongs to.

The HLR 114 searches for the location information of the receiving HAT 130 and transmits the SMSREQ message (SMSREQ[MIN]) to the MSC 104 in step 607.

In step 609, the MSC 104 transmits to the HLR 114 an smsreq message (smsreq[SMSADDR]) as a response message for the SMSREQ[MIN] message including the SMSADDR of the HAT 130 required to transmit the SMS message to the HAT 130. In step 611, the HLR 114 transmits the received smsreq message including the SMSADDR to the SMSC 112.

The SMSC 112 generates an SMDPP message (SMDPP[MIN]) including the MIN of the HAT 130 and the SMS message using the SMSADDR and transmits it to the MSC 104 in step 613. The MSC 104 then determines whether radio resources have been allocated to the HAT 130.

If the radio resources have not been allocated to the HAT 130 yet, the BSC 102 transmits a PAGE message (PAGE(SMS)) to the HAT 130 in step 615. In step 617, the HAT 130 returns a PAGE RESPONSE message to the BSC 102.

The BSC 102 and the MSC 104 allocate radio resources including a TCH to the HAT 130 in step 619.

If the radio resources have already been allocated to the HAT 130, steps 615, 617 and 619 need not be performed.

In step 621, the MSC 104 transmits an SMS-Mobile Terminated (SMS-MT) message including the SMS message to the HAT 130 using the allocated radio resources.

The HAT 130 transmits an SMS-ACK message to the MSC 104 in step 623, and the MSC 104 transmits an smdpp message (smdpp[ACK]) as a response message for the SMDPP message in step 613 to the SMSC 112 in step 625.

The SMSC 112 transmits an smdpp message (smdpp[ACK]) as a response message for the SMDPP message in step 603 to the transmitting SMGW 214 in step 627. In step 629, the SMGW214 transmits a 200 OK message to the HAT 141, as a response for the SMS request.

In the case where the AR 118 in the IP network receives an IP packet from an external network such as the cellular network, the AR 118 transmits the IP packet to the AP 116 to which a receiving HAT belongs, in the following procedure.

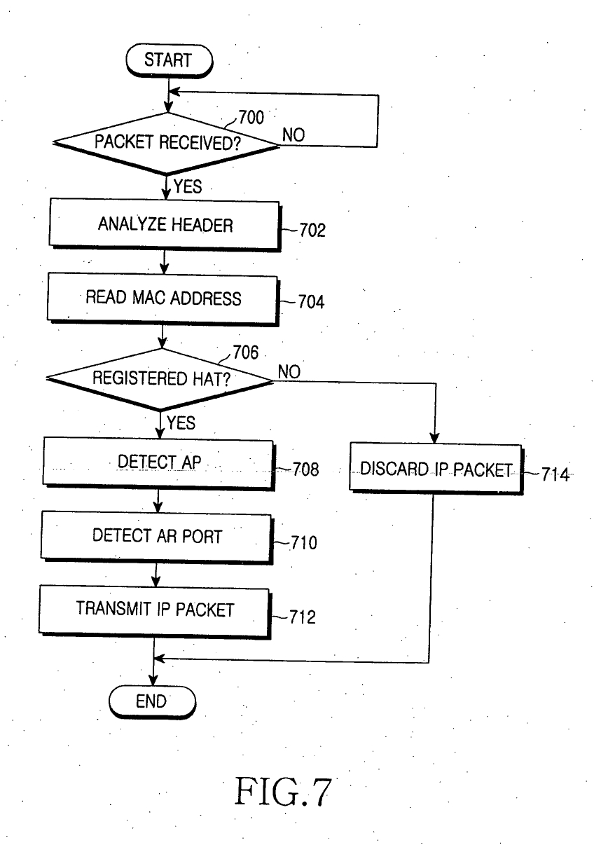

FIG. 7 is a flowchart illustrating an operation for transmitting a received IP packet from the AR 118 to the AP 116 according to an exemplary embodiment of the present invention.

Referring to FIG. 7, the AR 118 determines whether an IP packet has been received from an external IP network in step 700. Upon receipt of an IP packet from the external IP network, the AR 118 analyzes the header of the IP packet in step 702. The AR 118 reads the Medium Access Control (MAC) address of a receiving HAT from the IP header in step 704.

In step 706, the AR 118 determines whether the receiving HAT is a HAT registered to the AR 118. If it is not, the AR 118 discards the IP packet in step 714.

If the receiving HAT was registered to the AR 118, the AR 118 detects the AP 116 connected to the receiving HAT in step 708 and detects an AR port connected to the AP 116 in step 710. The AR 118 then transmits the IP packet to the AR 116 through the AR port in step 712.

As described above, certain exemplary embodiments of the present invention enable an SMS service between a cellular mobile communication network and a WLAN and thus provide mobility between the heterogeneous networks to users.

In addition, since an SMGW is further defined without any modification to the existing network configurations, the number of components to be added to provide the SMS between heterogeneous networks may be minimized and mobile service and WLAN providers can provide the SMS more easily.

While the present invention has been particularly shown and described with reference to certain exemplary embodiments thereof, it will be understood by those of ordinary skill in the art that various changes in form and detail may be made therein without departing from the spirit and scope of the present invention as defined by the appended claims.

What is claimed is:

1. A method of transmitting a short message service (SMS) message from a transmitting mobile terminal (MT) connected to a mobile communication network to a receiving MT connected to a wireless local area network (WLAN) in a short message gateway (SMGW), the method comprising:
converting, upon request for transmission of an SMS message from the transmitting MT, an identifier (ID) of the receiving MT to a uniform resource identifier (URI) of the receiving MT according to an IP address of the receiving MT; and
transmitting the SMS message to the receiving MT according to the uniform resource identifier (URI) of the receiving MT.

2. The method of claim 1, wherein the ID of the receiving MT comprises a mobile identifier number (MIN).

3. A method of transmitting a short message service (SMS) message from a transmitting mobile terminal(MT) connected to a wireless local area network (WLAN) to a receiving MT connected to a mobile communication network in a short message gateway (SMGW), the method comprising;
Converting, upon request for transmission of an SMS message from the transmitting MT, a uniform resource identifier(URI) of the transmitting MT to an identifier (ID) of the receiving MT according to an IP address of the receiving MT; and
transmitting the SMS message to the receiving MT according to the identifier (ID) of the receiving MT.

4. The method of claim 3, wherein the ID of the receiving MT comprises a mobile identifier number (MIN).

5. A short message gateway (SMGW) for transmitting a short message service (SMS) message between a first mobile terminal (MT) connected to a mobile communication network and a second mobile terminal (MT) connected to a wireless local area network (WLAN), the SMGW comprising;
a protocol processor for converting an identifier (ID) of the second MT to a uniform resource identifier (URI) of the second MT according to an IP address of the second MT;
a subscribe information database for storing information about the location of the first MT of the second MT;
a first interface for coupling data between the mobile communication network and the first protocol processor; and
a second interface for coupling data between the second protocol processor and the WLAN.

6. The SMGW of claim 5, wherein the protocol processor comprises;
a first protocol processor for signaling with a short message service center and a home location register in the mobile communication network; and
a second protocol processor for signaling with an access router and access point in the WLAN.

7. A method of transmitting a short message service (SMS) message from a transmitting mobile terminal (MT) connected to a mobile communication network to a receiving MT connected to a wireless local area network (WLAN), the method comprising:
asking, upon request for transmission of an SMS message from the transmitting MT, a home location register (HLR) about the location of the receiving MT by an SMS center (SMSC);
searching an internal database and transmitting an SMS request message to a short message gateway (SMGW) that can transmit the SMS message to the receiving MT by the HLR, when the receiving MT is connected to the WLAN;
transmitting a SMS request response message to the SMSC by the SMGW when the receiving MT is within the coverage area of the SMGW;
transmitting a SMS delivery point-to-point message comprising an identifier (ID) of the receiving MT to the SMGW by the SMSC; and
transmitting the SMS message to the receiving MT by the SMGW.

8. The method of claim 7, wherein the ID of the receiving MT comprises a mobile identifier number (MIN).

9. The method of claim 7, wherein the SMS message transmitted from the SMGW to the receiving MT comprises a uniform resource identifier (URI) and the contents of the SMS message originate from the transmitting MT.

10. A method of transmitting a short message service (SMS) message from a transmitting mobile terminal (MT) connected to a wireless local area network (WLAN) to a receiving MT connected to a mobile communication network, the method comprising:
transmitting, upon request for transmission of a SMS message from the transmitting MT, an SMS delivery point-to-point message to a SMS center (SMSC) by a short message gateway (SMGW);
transmitting an SMS request message to a home location register (HLR) requesting the location of the receiving MT by the SMSC;
detecting the location of the receiving MT and transmitting the SMS request message to a mobile switching center (MSC) by the HLR;
transmitting an SMS request response message as a response message for the SMS request message to the HLR by the MSC;
transmitting the SMS request response message to the SMSC by the HLR; and
transmitting the SMS message to the receiving MT by the SMSC.

11. The method of claim 10, wherein the SMS delivery point-to-point message transmitted from the SMGW to the SMSC comprises an identifier of the receiving MT.

12. The method of claim 11, wherein the ID of the receiving MT comprises a mobile identifier number (MIN).

13. A system for transmitting a short message service (SMS) message from a transmitting mobile terminal (MT) connected to a mobile communication network to a receiving MT connected to a wireless local area network (WLAN), the system comprising:
a SMS center (SMSC) for receiving an SMS request message from the transmitting MT;
a home location register (HLR) for receiving the SMS request message from the SMSC; and
a short message gateway (SMGW) for receiving the SMS request message from the HLTR, transmitting a response message for the SMS request message to the SMSC, and transmitting the SMS message to the receiving MT according to the SMS delivery point-to-point message received from the SMSC,
wherein the SMSC requests from the HLR the location of the receiving MT, and transmits an SMS delivery point-to-point message to the SMGW, the SMGW being configured to transmit the SMS message originating from the transmitting MT to the receiving MT,
and wherein the HLR transmits the SMS request message to the SMGW according to the location of the receiving MT.

14. The system of claim 13, wherein the SMGW converts an identifier (ID) of the receiving MT included in the SMS delivery point-to-point message to a uniform resource identifier (URI) of the receiving MT.

15. The system of claim 14, wherein the ID of the receiving MT comprises a mobile identifier number (MIN).

16. A system for transmitting a short message service (SMS) message from a transmitting mobile terminal (MT) connected to a wireless local area network (WLAN) to a receiving MT connected to a mobile communication network, the system comprising:
a short message gateway (SMGW); and
a SMS center (SMSC) for receiving the an SMS delivery point-to-point message from the SMGW, requesting the location of the receiving MT from a home location register (HLR), and transmitting the SMS message to the receiving MT when the receiving MT is located,
wherein the SMGW, upon request for transmission of an SMS message from the transmitting MT, transmitting the SMS delivery point-to-point message to the SMSC, the SMSC being configured to transmit the SMS message to the receiving MT.

17. The system of claim 16, wherein the SMGW converts a uniform resource identifier (URI) of the transmitting MT included in the SMS request message received from the transmitting MT to an identifier (ID) of the receiving MT.

18. The system of claim 16, wherein the SMS delivery point-to-point message comprises the ID of the receiving MT.

19. The system of claim 16, wherein the ID of the transmitting MT comprises a mobile identifier number (MIN).

20. The system of claim 17, wherein the ID of the transmitting MT comprises a mobile identifier number (MIN).
